(19) United States
(12) Patent Application Publication
(10) Pub. No.: US 2011/0220096 A1
(43) Pub. Date: Sep. 15, 2011

(54) Concentrated solar trough and mobile solar collector

(75) Inventors: Naveen N. Margankunte, Honolulu, HI (US); Josef A. Sikora, Honolulu, HI (US); Darren T. Kimura, Mililani, HI (US); Peter J. Sugimura, Aiea, HI (US); Kip H. Dopp, Newcastle, WY (US)

(73) Assignee: SOPOGY, INC., HONOLULU, HI (US)

(21) Appl. No.: 12/931,700

(22) Filed: Feb. 7, 2011

Related U.S. Application Data
(63) Continuation of application No. PCT/US2009/004539, filed on Aug. 6, 2009.
(60) Provisional application No. 61/188,240, filed on Aug. 6, 2008.
(60) Provisional application No. 61/195,291, filed on Oct. 3, 2008.

(51) Int. Cl. F24J 2/10; B23P 19/00

(52) U.S. Cl. 126/684; 29/426.2

(57) ABSTRACT

Solar energy reflector, collector, array, and other equipment for converting solar energy to e.g. thermal energy. A reflector or collector may, for instance, comprise a plurality of longitudinal rails; a rib engaging and spanning the plurality of longitudinal rails; and a first mirror panel. The rib of the reflector or collector may have a slot that is parabolic or in the shape of a section of a parabola. A portion of the mirror panel such as an end portion or a portion located away from the ends may be positioned within the rib's slot.

This application claims benefit of priority to U.S. Application Ser. No. 61/188,240 filed Aug. 6, 2008 entitled “Mobile Solar Collector”, inventors Darren T. Kimura and Naveen N. Margankunte, and to U.S. Application Ser. No. 61/195,291 filed Oct. 3, 2008 entitled “Concentrated Solar Trough ‘SopoFlare’”, inventors Darren T. Kimura, Josef A. Sikora, and Peter J. Sugimura, each of which is incorporated by reference in its entirety as put forth in full below. This application also incorporates by reference in its entirety, as if put forth in full below, each of the patent applications incorporated by reference in the above-listed provisional patent applications as well as all applications related by priority thereto as of today.

### BACKGROUND

Energy from the sun can be directly harnessed by several technologies: flat-panel solar water heaters, photovoltaic (PV) cells, and concentrating solar power (CSP) systems.

PV is linearly scalable. A single PV cell on a rooftop generates proportionally equal amounts of electricity as an acre of PV cells. This aspect makes PV useful for residential rooftops or for powering a road-side emergency phone, among other applications.

CSP becomes more efficient as the collection area increases. This has prompted the development of CSP systems that, for example, span large areas with individual collectors the size of a school bus.

At the small-scale level (for example, approximately 250 kW and below), flat-panel solar heating and photovoltaic (PV) units may provide relatively expensive but flexible solutions. At the large-scale level (for example, approximately 25 MW and above), utility-scale CSP installations may provide cost-efficient solar power production.

### SUMMARY

Provided herein is a reflector, collector, collector array, and other equipment and methods associated therewith. The equipment and methods discussed herein may be configured and utilized in many ways, and one way in particular is in Micro Concentrated Solar Power.

Micro Concentrated Solar Power (MicroCSP™) may provide a modular and scalable solar power technology that is suitable for electricity generation in the range of approximately 250 kW-20 MW, for example, while at the same time producing process heat that may be used for many industrial and commercial applications. MicroCSP™ technology is suited for providing process heat to a wide range of applications and purposes, including, for example, natural gas offsetting applications such as crop drying and food preparation, industrial processes such as biofuels production, water purifications, desalination and absorption chiller air conditioning for commercial buildings. The hybridization of using thermal heat for both power generation and processes such as steam production and air conditioning may provide an advantage of MicroCSP™ over PV technology.

A MicroCSP™ collector can be a designed for placement on a smaller and/or irregular surface than is typically used for larger scale installations. Such a design preferably should be light enough so that costly structural reinforcement of the rooftop (or other surface) is unnecessary, yet strong enough to withstand the elements of nature. Certain parabolic troughs are designed to be placed on a horizontal surface. An alternative design may be placed on any surface which may have flat and/or sloping surfaces. In addition to rooftops, such alternative MicroCSP™ designs might also be placed on hillsides or other sloping surfaces.

Preferably, the design of such a collector will reduce the number of parts and machining steps and therefore be simpler and/or faster to manufacture and construct. The smaller number of parts may reduce the weight—which facilitates placement on a rooftop or a sloping or unstable surface. The reduction of parts may be achieved, for example, by combining several tasks into a single part. As opposed to ribs constraining the mirror in a single direction, as described in certain prior patent applications referenced above and in Appendix A, the ribs and end arms may be designed to constrain both the mirror and wind cover in all 3 directions (or all three axes x,y,z). Preferably, this can all be accomplished without need for a nut, bolt, screw, rivet, epoxy or any other type of fastening.

Although the design of the collector preferably should be light, it preferably should also be strong enough to withstand the elements. This constraint may limit the size of the collector area, thus limiting the maximum temperature the working fluid may reach. If the area of the collection area is large enough, power generation may still be possible. The collector may also be used for the production of process heat for industrial applications, absorption-chilling processes, and numerous other applications.

A reflector or collector as described above may, for instance, comprise a plurality of longitudinal rails; a rib engaging and spanning the plurality of longitudinal rails; and a first mirror panel. The rib of the reflector or collector may have a slot that is parabolic or in the shape of a section of a parabola. A portion of the mirror panel such as an end portion or a portion located away from the ends may be positioned within the rib's slot.

A reflector or collector may have multiple mirror panels. These panels may be positioned side by side along a longitudinal axis. Alternatively or additionally, panels may be positioned end to end or approximately end to end in a direction perpendicular to a longitudinal axis of the reflector or collector.

Individual reflectors or collectors may be ganged together to form a row that can be actuated by e.g. a single drive motor, and multiple rows of the same or different length may be placed near one another to form an array. Preferably, each individual reflector or collector (a “unit”) can easily be configured in size from a standard two-panel unit (having two mirror panels side by side), to a three-panel unit (having three mirror panels side by side) or other multi-panel unit. Since rooftops or sloping surfaces, or other locations where the units may be used, may be irregular in shape, this increases the amount space which can be utilized. A unit which only comes in one size may not utilize a significant amount of space at the ends of each row.

One or more rows of an array may therefore differ in length and in a number of ways. Rows may be formed of identical units, but various rows of the array have a different number of units. Some rows may be formed of a first-size unit while other rows are formed of a second-size unit, with the number of units in each row being either the same or different. Greater than about 70% of the total number of units in all rows may be formed using units having a first size, while less than about 30% of the total number of units in all rows may be formed using units having a second size. The length of one row may therefore be different from another row in the array to utilize areas of nonuniform shape.

For example, in an open field where a larger size unit might be deployed, rows might range from, for example, 15-50 units of larger units, with rows having the same size or having two or three or more different sizes. In a warehouse, or office building, or hospital, or other location, rows may range, for example, from 1 to 10's of units of the same size or of two or three or more different sizes. With the use of both two and three panel units (or other multipanel units), collection area may be increased without significant additional cost. The more irregular the rooftop or surface, the more benefit a variable length collector may provide.

Other reflector or collector designs may be provided or utilized. For instance, a reflector or collector may have (1) a plurality of longitudinal rails, in which at least one of the rails is at least partially hollow and has a slot on a longitudinal face that extends to an opening at an end of the rail to define a slotted rail; (2) a parabolic rib having a section at an end of the rib smaller than the slot of the rail to allow insertion of the rib-end into the slot; and (3) a first mirror panel having an end with a shape configured to engage with the end section of the rib and the slotted rail at the slot to maintain the rib, the mirror panel, and the slotted rail together.

Variations of the reflectors or collectors discussed above are described below. Any of the features discussed in the examples below may be found individually or in any combination with the reflectors and collectors discussed above.

### BRIEF DESCRIPTION OF THE FIGURES

FIG. 1 depicts an example of a reflector and collector.

FIG. 2 illustrates a structural frame.

FIG. 3 depicts a support stand whose height may be adjusted as desired by loosening bolts holding the bearing structure to a vertical support, sliding the bearing structure, and retightening the bolts.

FIG. 4 illustrates a reflector and collector.

FIGS. 5-8 illustrate various embodiments of ribs.

FIG. 9 depicts a multi-piece rib.

FIG. 10 illustrates an end arm.

FIG. 11 illustrates a feature of the end arm.

FIG. 12 illustrates multiple reflectors forming rows in which two reflectors share a stand.

FIG. 13 depicts a collector with different stand designs.

FIG. 14 depicts a bearing.

FIG. 15 is a cross-section of a mirror, wind cover, and rib retained by a clamp or rail having a slot.

FIGS. 16 and 17 illustrate solar energy absorbers.

FIGS. 18-21 illustrate various solar energy tubular absorbers.

FIG. 22 depicts one layout of components of a particular mobile collector.

### DETAILED DESCRIPTION OF EXAMPLE EMBODIMENTS

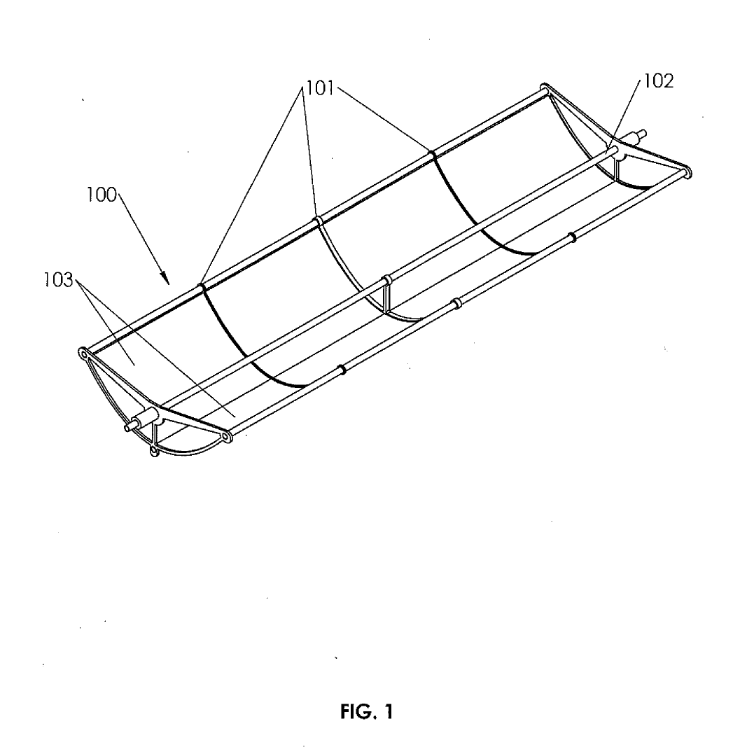

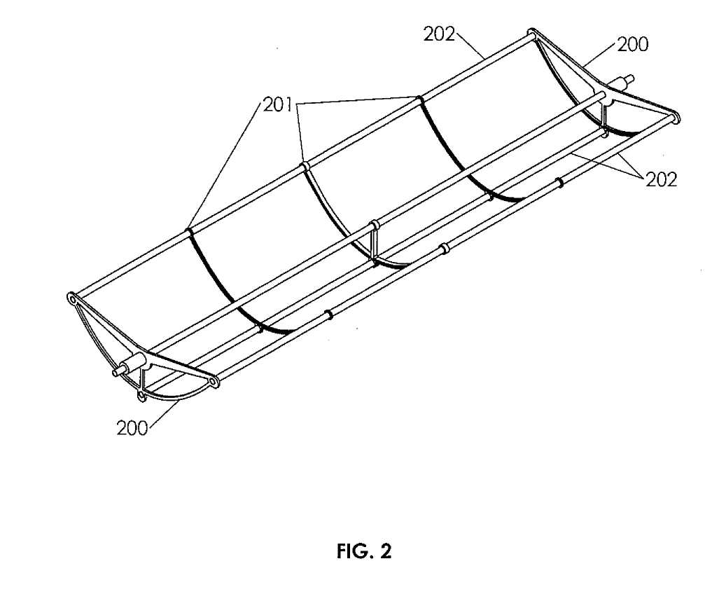

As shown in FIG. 1, a preferred embodiment of a collector 100 according to the present description may include three main systems—1) the main structural frame 101, 2) a thermal energy receiver 102, and 3) a flexible mirror 103. A preferred reflector will have the main structural frame and a mirror, which may or may not be flexible. The structural frame consisting of ribs and end arms are shown in FIG. 2 and will be described further below. Other equipment such as drive system, guy wires, flexible mirror, and other components, for example, may be present as well.

### Frame

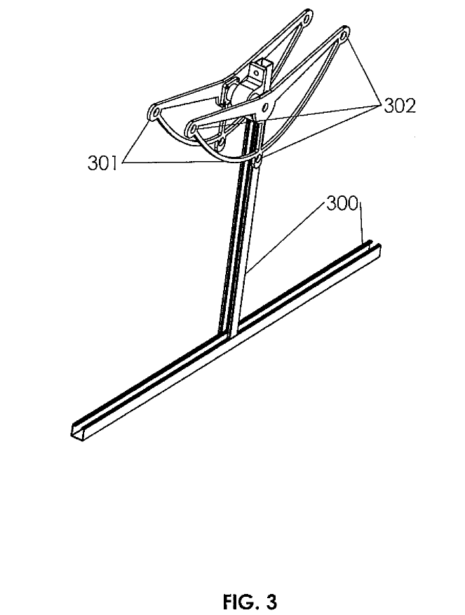

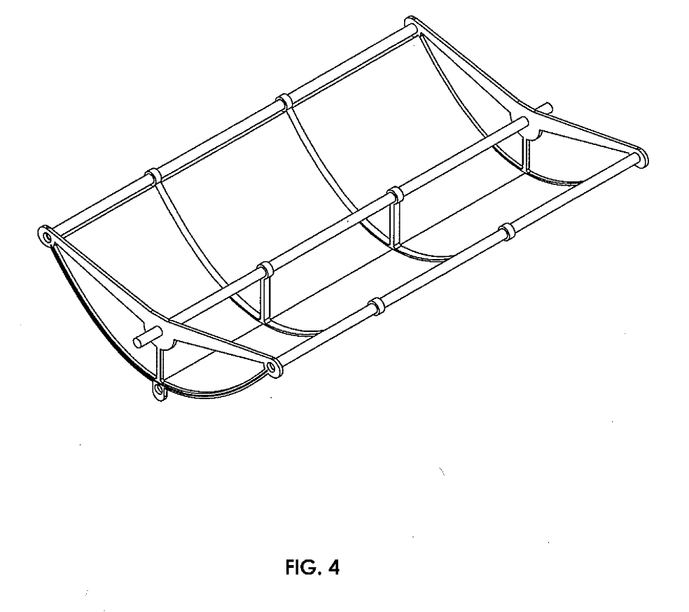

As shown in FIGS. 2-4, the main structural frame 101 of the reflector 100 may be composed of end arms 200, support ribs 201, longitudinal rails 202, and optional end stands 300 (an example of an end stand is shown in FIG. 3). Stands may be located at either or both ends of a reflector. Each end arm 301 may be attached to a stand facing towards the interior of the reflector. Each end arm may have holes 302 into which the longitudinal rails can be inserted. The rails may therefore be parallel to each other and perpendicular to the arms that support them. The ribs may be placed along the longitudinal rails and thus parallel to the end arms. The stands may be relatively stationary, but the end arms, ribs, and rails would be free to rotate as one unit about the longitudinal axis. The length of the frame may, for example, vary between a standard size, to roughly 0.5× standard size, or to roughly 1.5× standard size, among other options (see FIG. 4, illustrating a collector of 1.5× standard size corresponding to three main mirror sections, with the middle mirror section being formed of two mirror panels side by side). Mirror panels may be purchased in commercially-available widths (for instance, two foot, four-foot, five-foot, or six-foot widths, or 500 mm, 750 mm, 1000 mm, or 1500 mm widths). Thus, reflectors may have an aperture in the range of e.g. about 5-40 square feet, about 10-30 square feet, or about 15-25 square feet or approximately equivalent sizes using panels in standard metric sizes.

### Ribs

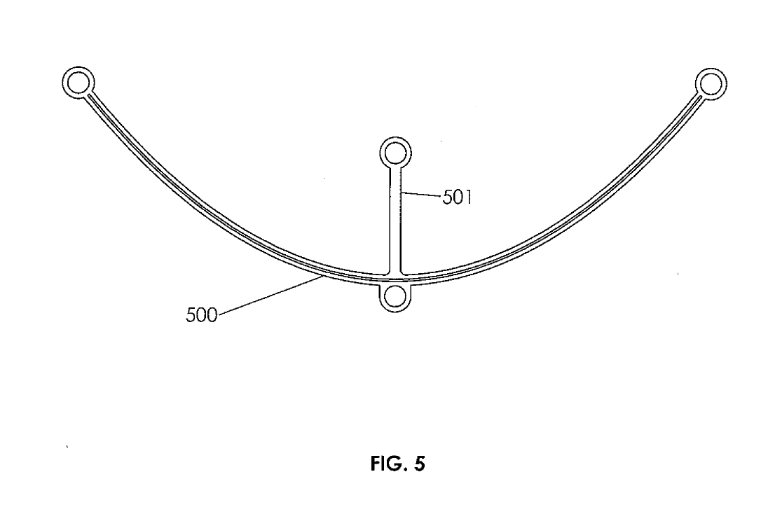

As shown in FIG. 5, preferably, there would be at least one central rib 500 for each mirror to mirror junction. For a reflector with two mirrors, one central rib would be used. For a reflector with three mirrors, two central ribs would be used. In general, there optimally should be N−1 central ribs at a minimum, where N is the number of mirrors. These central ribs preferably would have a parabolic shape. In any of the following cases, the central rib may optionally contain a vertical support for the heat collector 501.

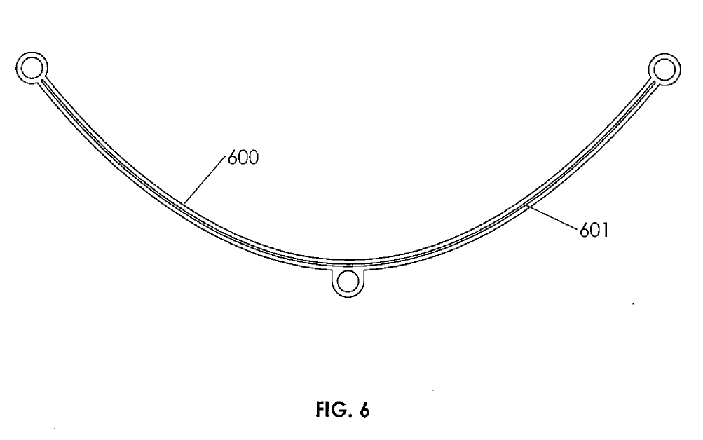

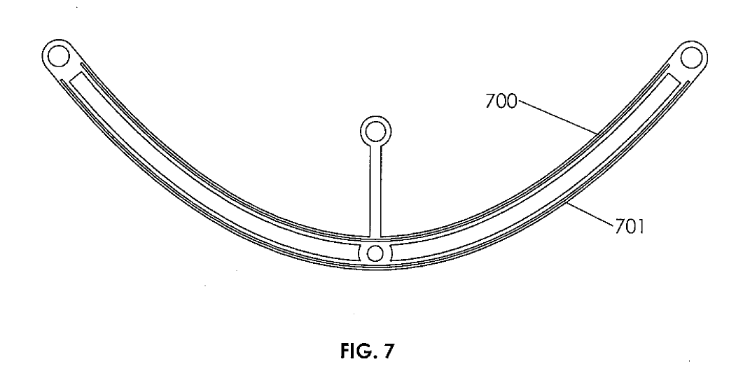

As shown in FIG. 6, the ribs 600 may have one or more parabolic slots 601 cut into them. Without necessarily requiring the use of clips, bolts, screws, or other fasteners, the ribs can constrain the mirror and/or wind cover not just from below but also from above and from side to side. Since the entire slot is parabolic in shape, even if the mirror slides along the parabola (in the transverse direction), the mirror should still retain a parabolic shape. A method may also be used to constrain them from motion in the last direction (longitudinally). If there is only one parabolic slot, it preferably should be thick enough to accommodate the thickness of both the mirror and the wind cover. If there are two parabolic slots as shown in FIG. 7, the top slot 700 can accommodate the mirror and the bottom slot 701 can contain the wind cover. The slot preferably should be slightly wider than the mirror or wind cover to ensure easy installation. The slot may extend through the whole rib, or they may just indent either side of the rib. Indentations in a central rib act to both constrain the edges of the mirror into a parabolic shape, and also ensure that the central rib remains at the connection between the two mirrors.

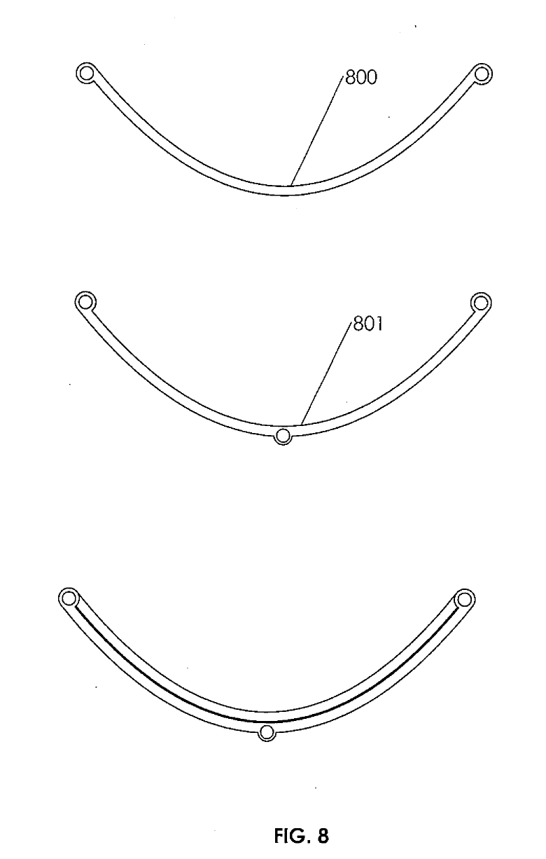

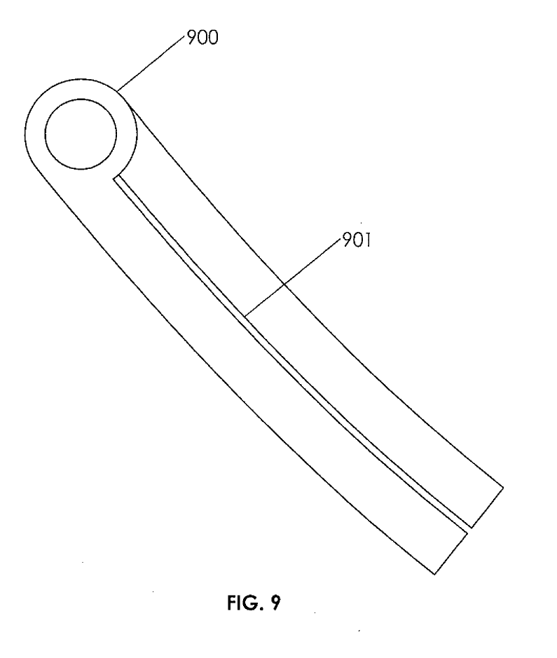

As an alternative to manufacturing ribs with a thin parabolic slot cut into them, the ribs may be split into two pieces as seen in FIG. 8. An upper rib 800 can confine the mirror from above while at the same time, a lower rib 801 confines the mirror from below. As shown in FIG. 9, the ribs can be placed coincident 900 to each other and may be fastened together. Between the two ribs can be a parabolic slot 901 which is wide enough for a mirror and/or wind cover. The top of the virtual slot can be composed of the bottom of the upper rib. The bottom of the virtual slot can be composed of the top of the lower rib. Thus, when the upper and lower rib are placed coincident to each other, they can form a virtual parabolic slot.

### End Arms

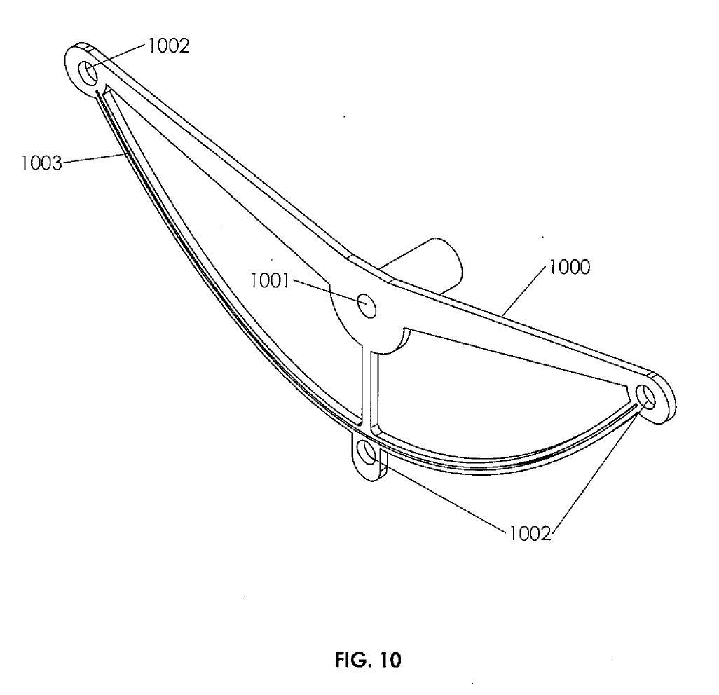

FIG. 10 depicts one type of end arm 1000. An end arm may contain a central hole 1001 for the heat collector and outer holes 1002 for longitudinal rails (FIG. 7). While FIG. 10 depicts holes for three rails, an end arm may have fewer or more holes for fewer or more rails. In one instance, there are two rail holes (left and right rail holes but not the center rail hole, for instance). The outer holes may optionally traverse entirely through the arm so that a rail may be inserted into and through the arm. Or, an arm may be indented to provide depressions so that the rails may be inserted into the holes formed by the depressions but are constrained from passing through the arm. The end arms preferably also contain a parabolic slot 1003. The end arm may have slots similar or identical to those of the central rib, and there may be the same variations of parabolic slot design (one vs. two slots, slot is an indentation or slot is entirely through the arm). If end arms have indentations for rails and/or mirror panels, then the rails and/or mirror and optional wind cover would be fully constrained in all three directions (preferably without the use of any bolts or screws, or other fasteners attaching end arms to rails and/or mirror panels).

Preferably, there should be a method to constrain the mirror from flexing and losing its parabolic shape. There are numerous options. One option is to add ribs. Depending on the design parameters (e.g. how strong a wind the trough must withstand), for each mirror segment one or more ribs may be added. These ribs will preferably contain the same parabolic slot(s) as the central rib, while end arms may have the same or different type of slot (partially or fully extending through end arms).

In one instance, none of the ribs have slots cut entirely through them, so each rib has a slot only partially through the rib. Edges of mirror panels insert into the slots, helping to maximize reflective surface area.

Some or all support ribs may have a parabolic slot cut through the entire rib. This may cover a portion of mirror area. However, this area may be recovered by adding a reflective strip to the rib surface which may be designed so that the surface is a parabola which focuses to the same focal point as the main mirror.

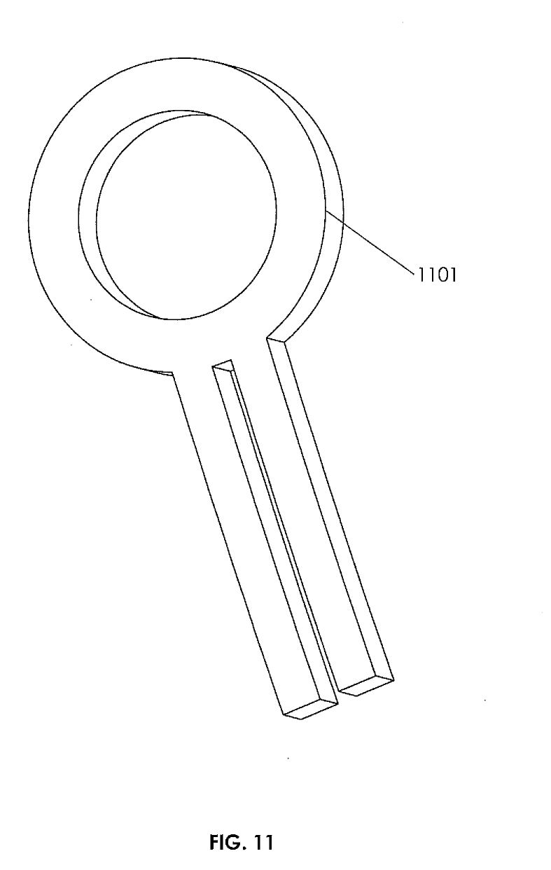

Another alternative to reduce the amount of mirror lost is to truncate the ribs as seen in FIG. 11. The tops of the parabolic mirror have the most error, so any area lost at mirror tops affects the total solar to thermal efficiency minimally. Also, the top of the parabola has the biggest slope, so a minimal amount of aperture area (area perpendicular to sun's rays) will be lost with the use of truncated ribs. These truncated ribs need not be as strong of a support as the full-length ribs since only the edges of the wind cover are held in place with the use of truncated ribs, central rib, and end arms.

Another option is to corrugate the wind cover along the longitudinal direction and eliminate the support ribs (or truncated ribs). The corrugations may stiffen the wind cover from flexing. The entire sheet may be corrugated, there may be only one corrugation, or any number in between.

Finally, a combination of any, some, or all, of the above options may be used in conjunction depending on the stresses the mirrors or reflectors will be required to withstand.

### Unistruts®

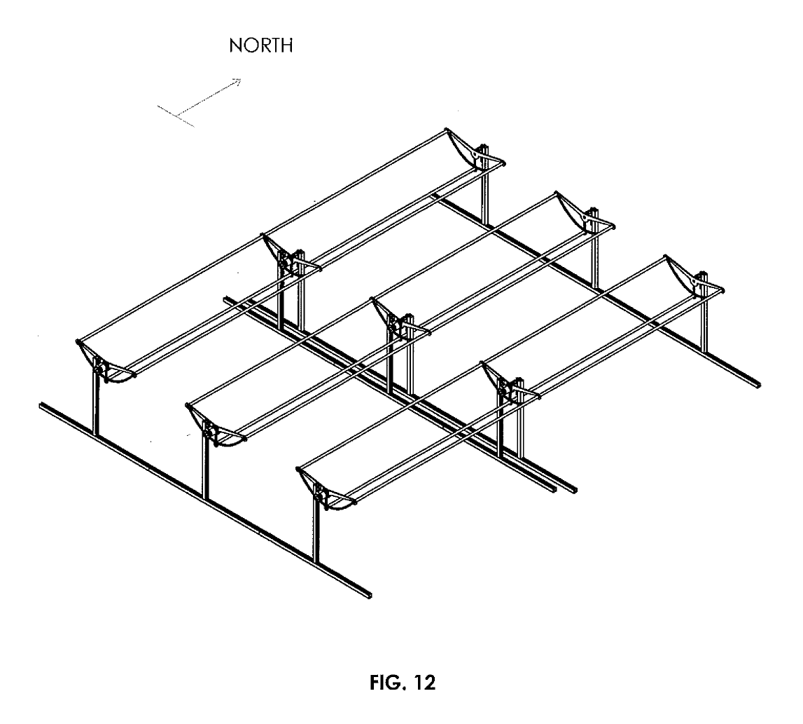

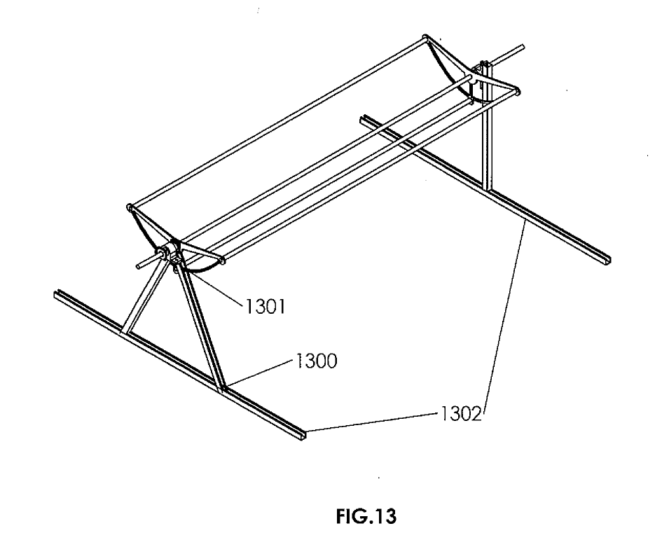

An optional roof to stand connection and stand may both be constructed out of Unistruts® (or any generic metal struts or equivalents). As FIG. 12 shows, the Unistruts® attached to the roof preferably should be oriented along lines of latitude (the east-west direction) and can be placed on either a horizontal or sloping roof or other surface. They may preferably be spaced apart equal to the length of the reflector plus one pillow block. The stands may then be formed by attaching Unistruts® to the rooftop Unistruts® (those which lay on the roof or other surface). The process follows: The rooftop Unistruts® may be placed on lines of latitude. L-brackets or angle bracket may be attached by a channel nut and bolt to the rooftop Unistruts®. Another Unistrut® may then be attached to the other end of the a bracket. The Unistruts® may then be placed at the necessary or appropriate angle 1300, and then a channel nut and bolt may lock it into the correct position.

Attached to the top of each Unistrut® stand may be a pillow block bearing 1301. The pillow block bearing may be oriented vertically or horizontally to allow for ease of connection to the stand. Pillow block bearings may be ordered in bulk and can be constructed of lightweight but strong material. The pillow block preferably should contain a built-in bearing (or have an external bearing inserted into it) so that the reflector can rotate, but the stand remains stationary. If the stand is constructed from Unistruts®, then the elevation of each pillow block may be set at the desired height 1302. This would allow a reflector to be oriented horizontally, even if the rooftop or other surface is slanted.

### Stand-Reflector Connection

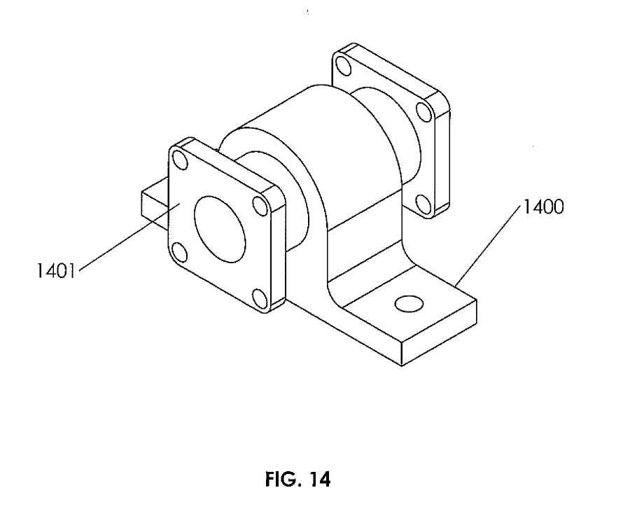

An example of a connection between the stand and the reflector will now be described. As shown in FIG. 14, inside of the pillow block bearing 1400, a flange pillow block 1401 may be placed. As with the pillow block bearing, the flange pillow block preferably contains a built-in bearing (or has an external bearing inserted into it). This allows the reflector to rotate freely while the heat collector remains stationary. Thus, the flange pillow block that connects to reflector end arms may be sheathed by two (e.g. graphite) bearings; one on the inside, one on the outside. The reflectors would then be free to rotate even while the thermal collection collector and the stands both remain stationary.

Either end of the flange pillow block may be attached by bolts and nuts, welding, epoxy, or other methods, to an end arm of a reflector. Thus, each stand can support the ends of two troughs. The stands at the end of each row may support one trough while the interior stands support two troughs. The total number of stands in a row may therefore be N+1, where N is the number of reflectors.

### Manufacturing

Manufacturing may be simplified. A CNC machine or laser cutting machine (or other device) can manufacture the end arms and ribs. The wind cover and mirror may be ordered as sheets with the required width. They can be cut to the required length by a metal cutting tool. Unistruts® are modular so they can be bought in bulk, then fitted together as necessary. The pillow block bearing and flange pillow blocks can also be bought off the shelf.

Alternatively, the ribs and end sections can be made using injection molding or die casting processes. The advantages of injection molding and die casting are that instead of multiple pieces of metal needing construction, with complicated machining involved, a single piece of light and strong carbon fiber or steel, respectively, may be mass produced once the mold is created.

If injection molding or die casting is unavailable in a certain region, or is not desired for other reasons, then the alternative design using an upper and lower rib may be chosen. The upper and lower ribs will be made from thin sheet metal. This allows their relatively simple shapes to be manufactured using a simple stamping process.

Construction of the trough can also be simplified. First, the longitudinal rails may be inserted into the central rib and any support ribs. Next, the mirror and wind cover may slide into place between the grooves of the rib(s). The end arms may then be added to cap the rails, mirror, and wind cover. To hold everything together, guy wires attaching same and/or opposite ends of end arms may then be tensioned to pull the end arms toward one another, forming a rigid structure.

### Maintenance

Maintenance may be simplified also. To replace a wind cover or mirror, the tension can be released from the guy wires, any support ribs can be slid to the end arms, the mirror/wind cover can be detached from the central rib, then from the end arm.

### Additional Options

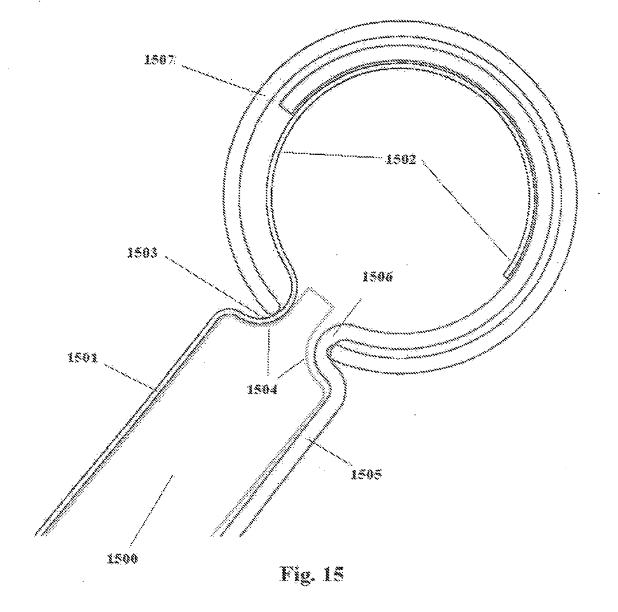

The flexible mirror and its associated supporting material is preferably the main portion of the reflector. The mirror is preferably made out of flexible material. As shown in FIG. 15 and e.g. FIG. 4, a flexible mirror 1501 may be constrained into a parabolic shape by ribs 1500 from below, and by an optional thin transverse strip from above. The mirror may be attached to the end rails via a bend 1502 with approximately the radius of the rail. When the reflector is assembled, the mirror may be slipped onto end rails. There also may be e.g. a small indentation 1503 near the rail whose use will be discussed below (spring clip section).

In certain reflector designs, three or more ribs may be used to mold the reflector into a parabolic shape. The ribs may be thin to reduce weight, but strong enough to keep their parabolic shape even while experiencing any typical stresses that may arise. They may be oriented parallel to the end arms, and perpendicular to the longitudinal rails. They may be machined with a hole in their mid-section equal to the size of a longitudinal rail. The hole may slide onto the bottom/central of the longitudinal rails. The tips of the ribs may be of the exact (or substantially exact) length to lie tangent to the top/outer longitudinal rails. In this way, the ribs would be unable to rotate independently. The ribs may have an indentation 1504 near the top/outer rails corresponding to the indentation in the flexible mirror.

The mirror may be constrained from above by a central support piece. The central support piece may serve various functions. One function may be to support the collection tube so that the tube is aligned with the parabolic trough's line of focus. Another function may be to clamp the mirror from the top. There could optionally be as many support pieces as ribs, with each support piece aligned with a support piece. The support piece may extend from the collector tube, down to the mirror, then travel the half-length of the mirror, up to a top/outer rail. In this embodiment, the piece could have an indentation just as it reaches the rail, but not contain the encircling bend around the rail.

### Wind Cover

As shown in FIG. 15, there may be a wind cover 1505 located below the ribs. The wind cover may protect the flexible mirror from the wind while also increasing the stiffness of the reflector. The skirt may extend the length and breadth of the rotating trough. It also may contain a small indentation 1506 before the end rails. Similarly to the mirror, it may nearly encircle the end rail. At the zenith of the skirt, there may be three slots corresponding to the ribs.

### Spring Clip

The mirror, bottom skirt, ribs, support piece may all be further secured by a spring clip 1507. The spring clip may be a cylindrical tube or rail the length of the reflector. A small slit may be included, whose width is slightly smaller than the combined width of the rib, mirror, support piece, and bottom skirt. This clip may slide over the parts described above and clamp down at the indentations. A rail may optionally be present in the space between the mirror and optional wind cover, so that first sides of the mirror and optional wind cover face an inner rail and second sides of the mirror and optional wind cover face an outer rail.

### Energy Collector

This section entitled “Energy Collector” discloses various configurations of thermal collectors that may be used in conjunction with a reflector to form a collector as described above. This section also discloses various other configurations that may or may not be related to thermal energy collectors. For example, photovoltaic devices are provided. The invention is therefore not limited by the foregoing text but, instead, includes various inventions other than thermal energy collectors.

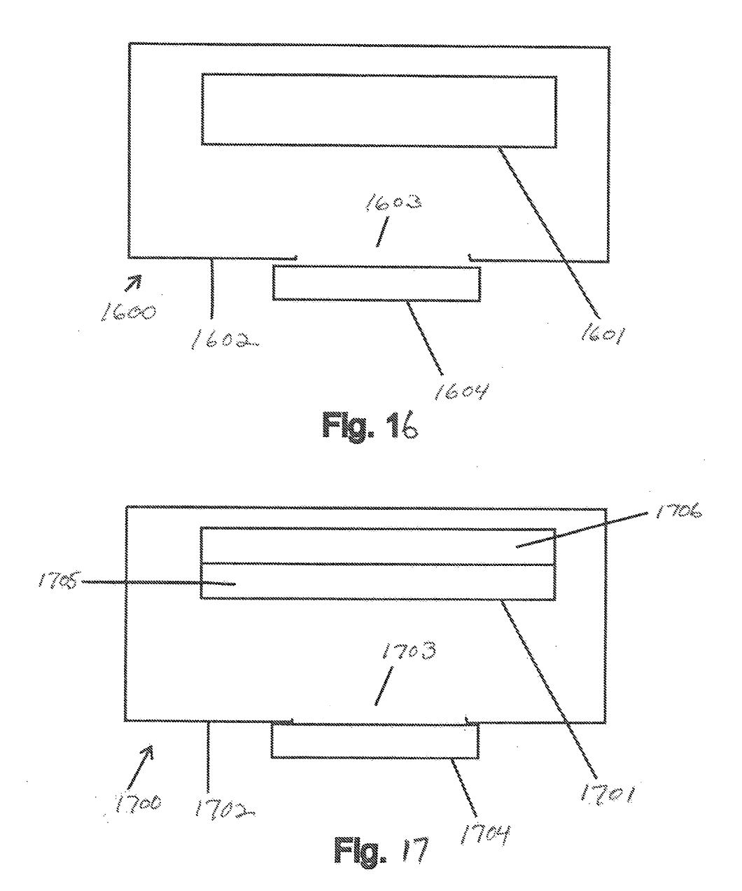

A solar energy absorber 1600 as depicted in FIG. 16 has three components: (1) a solar energy converter 1601 that converts solar energy to thermal or electrical energy; (2) a transparent housing 1602 having an opening 1603; and (3) a cover 1604 for covering the opening of the transparent housing. The cover 1604 depicted in FIG. 16 is a movable cover. Each of these components is discussed more fully below. A partial solar energy absorber may have: a solar energy converter and transparent housing with opening that have not been assembled; a solar energy converter and a cover for covering an opening of a transparent housing; a transparent housing with opening and its cover for covering the opening; or a solar energy converter, transparent housing, and cover that have not yet been assembled.

A solar energy absorber may be a solar-to-thermal energy absorber or a solar-to-electric energy absorber, for instance. A solar-to-thermal energy absorber is used in a solar-to-thermal energy collector to absorb solar energy and convert it to thermal energy for use in another process, such as in driving a shaft or a turbine. A solar-to-electric energy absorber is used in a solar-to-electric energy collector to generate electrical energy from the absorbed solar radiation.

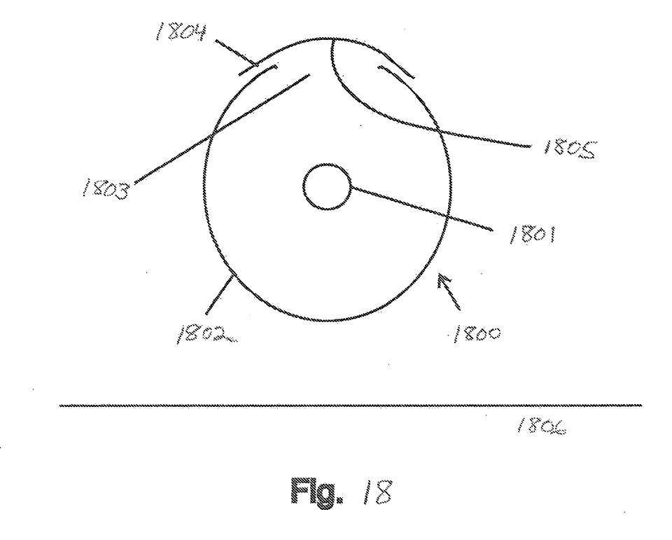

By way of example in FIG. 17, a solar-to-thermal energy absorber 700 has one or more plenums 1701 within a housing 1702 that is transparent or has a transparent portion and is positioned between a source of radiation such as the sun or a light-gathering surface such as a lens or mirror and the solar-to-thermal energy plenum 1701. A housing as discussed herein may be referred to as a “transparent housing” or “transparent tube”, although not all of the housing or tube need be transparent (the housing or tube could be entirely transparent if desired) to the frequencies of the electromagnetic spectrum of interest. The housing in this instance has one or more openings 1703 that are manually or automatically covered with one or more movable covers 1704 when the solar energy absorber is positioned to receive solar energy. The cover 1704 may be transparent and made of the same material as transparent housing 1702 to admit light to the solar-to-thermal energy collection plenum 1701 or plenums when the cover is in place on the transparent housing. The plenum 1701 contains water 1705 and steam 1706 generated by concentrated solar energy illuminating an area of the bottom of plenum 1701. The opening(s) may be positioned to face a maintenance or resting position such as toward earth as depicted when the solar energy absorber is not to receive solar energy, allowing any condensate to drain from the opening(s) before the assembly is returned to service. The inner surface of the transparent housing may be washed, as may be the solar-to-thermal energy collection plenum 1701, to remove any dust or dirt that may have entered the solar energy absorber during operation.

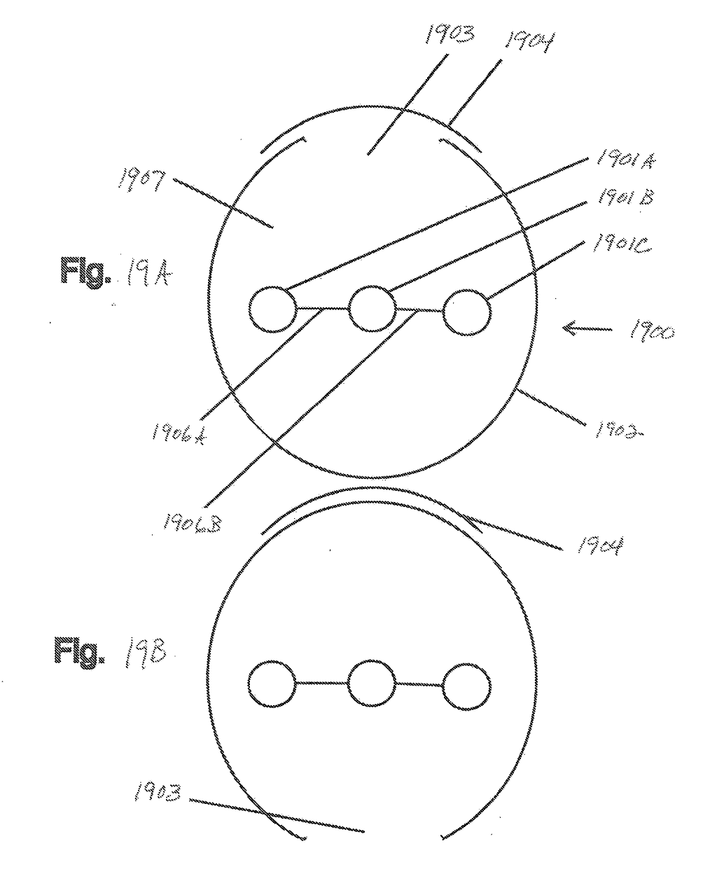

In another instance depicted in FIG. 18, a solar energy tubular absorber 1800 has one or more solar-to-thermal energy collection pipes 1801 within e.g. a tubular housing 1802 that is transparent or has a transparent portion to be positioned between a source of radiation such as the sun or a light-gathering surface such as a lens or mirror and a solar-to-thermal energy collection pipe. The tubular housing 1802 has one or more openings 1803 that are manually or automatically covered with one or more covers 1804 when the solar energy absorber is positioned to receive solar energy, and a reflective portion 1805 of cover 1804 may be positioned to reflect light to the solar-to-thermal energy collection pipes when the cover is in place on the transparent tube. The opening(s) 1803 may be positioned to face a maintenance or resting position such as toward earth 1806 when the solar energy absorber is not to receive solar energy, allowing any condensate to drain from the opening(s) before the assembly is returned to service. The inner surface of the transparent housing or tube may be washed, as may be the solar-to-thermal energy collection pipe, to remove any dust or dirt that may have entered the solar energy absorber during operation.

Details of each of the components of a solar energy absorber and solar energy collector are discussed below. Each variation of a component may be combined with each variation of the other components. Consequently, the disclosure in this application includes every combination of the different variations of the components specified herein.

Solar Energy Tubular Absorber

Referring to FIG. 18, a solar energy tubular absorber 1800 may have (1) one or more solar-to-thermal energy collection pipes 1801, (2) a transparent housing 1802 such as a tube having an opening 1803 and positioned about the solar-to-thermal energy collection pipe or pipes, and (3) one or more covers 1804 that can cover the opening 1803. The cover 1804 may be movable, or the transparent tubular housing 1802 may be movable, or both the cover and the transparent tubular housing may be movable.

Solar-to-Thermal Energy Collection Pipe

Referring to FIG. 18, the solar energy tubular absorber 1800 will have one or more solar-to-thermal energy collection pipes 1801. The pipe is preferably formed of a material that has a high heat transfer coefficient and can tolerate the temperatures encountered during use. The pipe may be formed of a suitable material such as a metal or alloy, including black iron, carbon steel, 304 and 316 stainless steel, copper, and aluminum.

A solar-to-thermal energy collection pipe 1801 may have a coating on its outer surface that increases the efficiency of solar energy collection. Such coatings include: black paint; black chrome; a three-layer coating comprised of metallic titanium, titanium oxide, and antireflection coating; aluminum nitride; black-colored CuCoMnOₓ formed using sol-gel synthesis; C/Al₂O₃/Al; or Ni/Al₂O₃ for instance. Any of the solar energy absorption coatings may have an antireflection coating upon them to increase absorption efficiency. Such coatings include silica, alumina, a hybrid silica formed of both tetraethoxysilane and methyltriethoxysilane for instance.

A solar-to-thermal energy collection pipe 1801 may have both ends open so that a working fluid to be heated such as oil or water may enter the first end of the pipe and exit the second end. A solar-to-thermal energy collection pipe may alternatively have only one end open, relying on natural convection and conduction to transfer heat from the working fluid to e.g. a reservoir or heat exchanger in fluid communication with the open end of the pipe.

FIG. 19A illustrates that multiple pipes or tubes 1901A, 1901B, 1901C within a chamber 1907 defined by transparent housing 1902 and enclosed by cover 1904 may be joined into a conduit array if desired, and in some instances, the pipes or tubes may be joined by e.g. heat fins 1906A, 1906B that conduct heat absorbed from adjacent pipes and/or from solar radiation to adjacent pipes or tubes. A solar-to-thermal energy collector is therefore able to focus collected sunlight onto multiple tubes 1901A, 1901B, and 1901C and/or onto the heat fins 1906A, 1906B of its solar energy absorber 1900 to accommodate reflector and/or lens misalignment.

Transparent Housing

Referring again to FIG. 19, the transparent housing 1902 has a chamber 1907 that is sufficiently large to contain the solar-to-thermal energy collection pipe or pipes 1901A, 1901B, 1901C to be positioned within the chamber 1907 of the transparent housing 1902. The transparent housing also has at least one opening 1903 that allows access to the chamber.

The amount of open area within the chamber (i.e. area not occupied by solar-to-thermal energy collection pipes) as well as the shape of the chamber are selected based on a number of factors specific to the purpose for the solar energy absorber with its accessible chamber. For instance, the solar energy absorber may have a single solar-to-thermal energy collection pipe 1801 positioned within the chamber and exposed to concentrated solar energy, as depicted in FIG. 18. The chamber shape may therefore be cylindrical, with sufficient spacing between the interior wall of the transparent housing and exterior wall of the solar-to-thermal energy collection pipe that cleaning water sprayed into the chamber through the opening(s) contacts much of the pipe and the interior wall of the transparent housing.

The one or more openings may therefore also have a size and shape that allows the desired access to the chamber. In one instance, the opening runs the entire length of the transparent housing (e.g. tube). The opening may be as wide as or wider than a pipe or pipe array that is to reside within the chamber of the transparent housing. A solar energy tubular absorber may be formed by placing the transparent housing over a solar-to-thermal energy collection pipe during assembly, easing installation of the transparent housing.

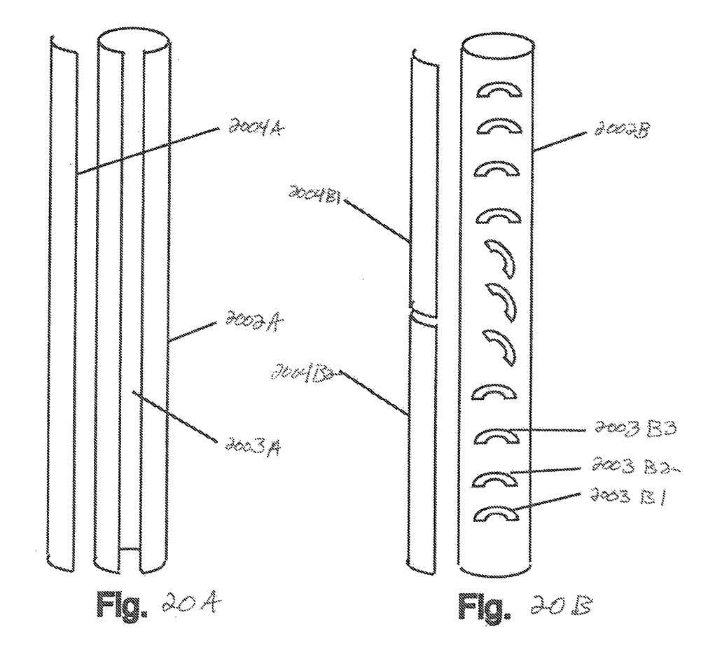

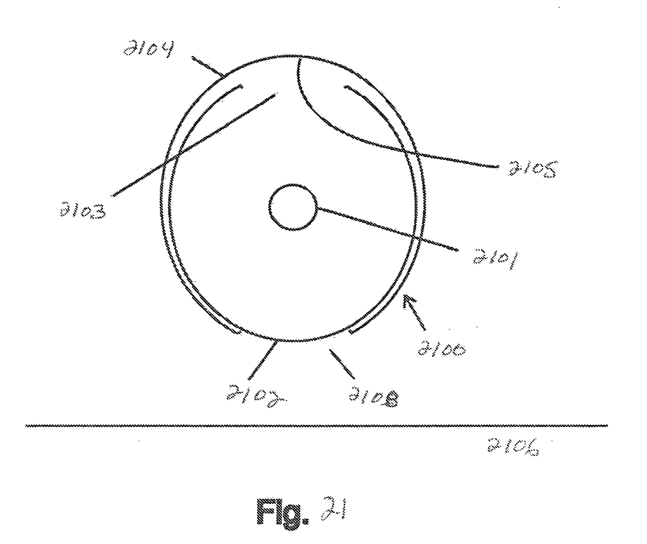

The opening 2003A in the transparent housing 2002A may therefore be one long opening from end to end as illustrated in FIG. 20A. Alternatively, as illustrated in FIG. 20B, there may be one or more openings 2003B1, 2003B2, 2003B3, etc., along the length of the housing 2002B, and not necessarily along a line from end to end, which allow multiple sprayers to spray liquid and/or gas such as compressed air into the chamber, or which allow condensation to drain from the assembly.

In one instance, the openings are large enough to allow a spray of air and/or water to clean the solar energy absorption pipe as well as much or all of the inside surface of the transparent tube. The tube may have multiple openings or one opening that permits easy drainage.

The transparent housing may be transparent to UV, visible, and/or infrared light. Preferably the housing is transparent to at least the sun's visible and infrared radiation. The housing may be formed of glass such as Pyrex or borosilicate glass. Alternatively, the housing may be formed of e.g. an acrylic polymer such as polymethylmethacrylate, a butyrate, a polycarbonate, or other polymer that admits at least 70% of the sunlight incident upon it.

The housing may have a shape that is convenient for the particular installation. In some instances, the housing will have the shape of a hollow rectangular prism 1602 as illustrated in FIGS. 16 and 17. This shape is useful when multiple pipes are present side-by-side or when a solar cell array is placed within the transparent housing (as discussed further below). In other instances (especially where a single solar-to-thermal energy collection pipe is present), the transparent housing 1802 is tubular as depicted in FIGS. 18, 19A, and 19B. The surface or surfaces of the housing through which most of the sunlight passes may be shaped to provide small angles of light incidence upon the surface or surfaces so that light reflection is reduced.

Ends of the transparent housing may be sealed so that an ambient atmosphere is largely contained within the chamber of the housing when a cover is placed on or in the opening of the housing. This configuration is especially useful where the solar energy converter is to convert sunlight to heat. Consequently, a solar-to-thermal energy absorption pipe will often be placed within a chamber having ends that are largely or wholly sealed around the pipe. End seals between housing and pipe may be pliable or movable to allow thermal expansion without undue stress being created on the ends of the housing and/or on the pipe. End seals may therefore be resilient polymer such as silicone that can tolerate temperatures encountered in use, folded metal that compresses and expands during heating and cooling cycles, or short cylinders of metal or other suitable material that have an opening of sufficient size that pipe and seal do not contact one another or barely contact one another in their fully expanded states.

Alternatively, ends or other portions of the housing may be open or have conduits that admit a gaseous or liquid stream that passes into and/or out of the chamber. A gas such as air may be introduced by way of the ends or conduit(s) to heat the gas and use it for process heat outside the housing, such as for heating the interior of a house. Likewise, a liquid such as water may pass through the chamber of the transparent housing to allow the water as well as the fluid passing through a collection pipe to be heated.

A transparent housing may be stationary, or a housing may be movable. A housing such as a rectangular prismatic housing or a tubular housing may be tilted away from a cover, for instance. Or, as depicted in FIGS. 19A and 19B, a transparent housing such as a transparent tubular housing 1902 may rotate about its longitudinal axis sufficiently to allow at least part of its opening 1903 to face earth, allowing any condensate, wash water, or other liquid or gas having a density greater than air to exit the chamber 1907.

Cover

A cover 1604, 1704, 1804 in FIGS. 16, 17, and 18 for the openings is often movable, although a cover 1904 may be stationary as depicted in FIGS. 19A and 19B. A cover may fit within or upon the one or more openings 1603, 1703, 1803, 1903, 2003A, and 2003B1, 2, etc. formed in the transparent tube. One cover may be used to cover one or more openings in the transparent tube, or more than one cover may be used to cover one or more openings, especially where the tube is long. Consequently, one opening may be covered by two or more covers 2004B1 and 2004B2 as depicted in FIG. 20B, or multiple openings may be covered by one cover 2004A as depicted in FIG. 20A. A cover may be manually moved from an opening, or a cover may be automatically moved from an opening. A cover 1904 may instead be stationary, as depicted in FIG. 19.

A cover may be formed of any suitable material. Considerations in selecting a material from which to form a cover include (a) whether the cover itself will transmit light, in which case the material would be transparent to the desired light wavelengths; (b) whether the cover is to be reflective; (c) the operating temperature range and/or peak temperatures that the cover will encounter; (d) how well the material of the cover seats onto the thermal solar energy absorption pipe; (e) weight, rigidity, and/or strength of the cover material; and any other considerations appropriate to use.

In one instance, a cover is formed of a metal and has a surface 305 as depicted in FIG. 3 that reflects at least 50% of the radiation incident upon it, and preferably the surface reflects greater than 80% or greater than 90% of the radiation incident upon it. The cover may be e.g. aluminum (polished or unpolished), or it may be formed of a metal such as stainless steel that has high rigidity. The metal may optionally be silvered to make a reflective surface. The cover may be formed of a thermally insulating material such as a polymer (e.g. a rigid polymer such as a polycarbonate, polyamide, or polyimide) and may also have a mirrored coating to reflect light.

The cover may be flat as depicted in FIGS. 16 and 17 or curved as depicted in FIGS. 18, 19A, 19B, 20A, and 20B. A curved cover may have a circular or parabolic arcuate profile, for instance. The cover may have the same curvature as a transparent tubular housing, or the cover may have a different curvature. For instance, the cover may be parabolic while the tube is generally circular in profile. If the cover is reflective and arcuate, the curvature of the arc (e.g. circular arc or parabolic arc) is preferably one that focuses solar energy upon the solar-to-thermal energy absorbing pipe when the cover is seated upon the transparent tube.

As illustrated in FIG. 21, in one instance a cover is a second transparent tube 2104 having an inner diameter that is slightly larger than the outer diameter of the transparent housing tube. The second transparent tube 2104 is fitted over the transparent tubular housing 2102, and the second transparent tube 2104 has one or more openings 2108 that coincide with the opening 2103 or openings present in the transparent housing tube when the transparent housing tube rotates. The transparent housing tube may be stationary, and the second transparent tube may be rotated about its longitudinal axis to align the opening(s) of the second transparent tube to the opening(s) of the transparent housing tube when the solar energy collector is not in use. The space between the two tubes is preferably kept to a minimum to minimize the effect that change in refractive index has on the path that light takes as it passes through both tubes and the air space. The second transparent tube 2104 may have a reflective coating 2105 on a portion of its inner surface and an antireflection coating on a portion of its outer surface through which solar radiation will pass, and an antireflective coating on the transparent housing tube 2102 may be the same as or different from the antireflective coating on the second transparent tube 2104 (for instance, the coating on the transparent housing tube may be selected to better accommodate light that has been refracted by the second transparent tube). Either or both of the transparent housing tube 2102 and the second transparent tube 2104 may be shaped so that the tube acts as a lens to better direct solar radiation toward a solar energy converter such as a solar-to-thermal energy collection pipe.

Solar Energy Rectangular Prism Absorber

Referring to FIGS. 16 and 17, a solar energy rectangular prism absorber 1600 and 1700 may have (1) one or more solar energy converters 1601 and 1701, (2) a transparent generally rectangular prism-shaped housing 1602 and 1702 having an opening and positioned about the solar energy converter or converters 1601 and 1701, and (3) one or more covers 1604 and 1704 that may be positioned on or in the opening to cover it.

Solar Energy Converters

Solar energy converters convert solar energy to another form of energy. A solar energy converter may be a solar-to-thermal energy collector pipe as discussed above. A solar energy converter may be a solar-to-thermal energy collector box 1701 having straight/and or curved sides, as illustrated in FIG. 17. A collector box allows light to be focused to a point beyond the box or somewhat defocused, so that a larger area of the collector box 1701 may be illuminated with concentrated electromagnetic radiation than is typically illuminated in e.g. a trough solar energy collector. A solar energy converter 1601 may be a solar cell that converts sunlight and/or heat to electricity, such as a photovoltaic device, module, or array, a thermoelectric device, module, or array, or a pyroelectric device, module, or array.

Photovoltaic devices include silicon-based photovoltaic cells, bulk photocells, thin-film photocells such as CdTe and CuInSe₂ photocells, single-junction photocells, multi-junction photocells such as GaAs based photocells, light absorbing dye-based photocells, polymeric photocells, and nanocrystal solar cells.

Thermoelectric generators may be Seebeck devices made from e.g. Bi₂Te₃. Pyroelectric devices may be formed of crystals of e.g. GaN, CsNO₃, and other compounds.

More than one type of converter may be present within a transparent housing. For instance, a housing may contain both solar-to-thermal energy collector pipe(s) and solar cells, or pipe(s) and thermoelectric generators, or pipe(s), solar cells, and thermoelectric generators.

Transparent Housing

The transparent housing 1602, 1702 of FIGS. 16 and 17 has a chamber that is sufficiently large to contain the solar energy converters 1601, 1701 to be positioned within the chamber of the transparent housing. The transparent housing also has at least one opening 1603, 1703 that allows access to the chamber.

The amount of open area within the chamber (i.e. area not occupied by solar energy converters) as well as the shape of the chamber are selected based on a number of factors specific to the purpose for having a solar energy absorber with accessible chamber. For instance, the solar energy absorber may have multiple photovoltaic cells positioned within the chamber and exposed to normal incident radiation or to concentrated solar radiation. The chamber shape may therefore be rectangular prismatic, with sufficient spacing between an interior wall of the transparent housing and photovoltaic cells to allow a desired flow of cooling gas to pass between the interior wall and the photocells to cool the cells to a desired operating temperature.

The housing may have a shape that is convenient for the particular installation. In some instances, the housing will have the shape of a hollow rectangular prism. This shape is useful when multiple pipes are present side-by-side (such as the pipe array of FIGS. 19A and 19B) or when a collector box is used or when a solar cell array is placed within the transparent housing. In other instances (especially where a single solar-to-thermal energy collection pipe is present, as noted previously), the transparent housing is tubular. The surface or surfaces of the housing through which most of the sunlight passes may be shaped to provide small angles of light incidence upon the surface or surfaces so that light reflection is reduced.

The housing may be transparent in areas where it light is to pass and may be translucent or opaque in other areas where, e.g., the housing is to be held by brackets or where structural rigidity is desired. Consequently, the transparent housing may have a transparent panel, and the remainder of the housing may be e.g. sheet-metal or opaque polymer. The transparent portion may be flat or may be shaped to provide improved efficiency in admitting light. For instance, the transparent portion may be curved from side to side to provide a low angle of incidence for light if light is reflected from a curved mirror. The transparent portion may have one or more lenses formed in it to focus light onto solar energy converters within the housing.

The one or more openings may have a size and shape that allows the desired access to the chamber. In one instance, an opening runs the entire length of the transparent housing. The opening may be as wide as or wider than a pipe or PV or thermoelectric module that is to reside within the transparent housing.

In one instance, the openings are large enough to allow a spray of air and/or water to clean the solar energy converters as well as much or all of the inside surface of the transparent housing. The housing may have multiple openings or one opening that permits easy drainage.

The transparent housing may be transparent to UV, visible, and/or infrared light. Preferably the housing is transparent to at least the sun's visible and infrared radiation. The housing may be formed of glass such as Pyrex or borosilicate glass. Alternatively, the housing may be formed of e.g. an acrylic polymer such as polymethylmethacrylate, a butyrate, a polycarbonate, or other polymer that admits at least 70% of the sunlight incident upon it.

Ends of the transparent housing may be sealed so that an ambient atmosphere is largely contained within the chamber of the housing when a cover is placed on or in the opening of the housing. This configuration is especially useful where the solar energy converter is to convert sunlight to heat. Consequently, a solar-to-thermal energy absorption pipe or thermoelectric device will often be placed within a chamber having ends that are largely or wholly sealed. If a pipe runs through end-walls of the housing, the ends may be sealed as discussed above. Otherwise, housing walls may seal the ends.

Alternatively, ends or other portions of the housing may be open or have conduits that admit a gaseous stream that passes into and/or out of the chamber. A gas such as air may be introduced by way of the ends or conduit(s) to cool the solar energy converters present within the chamber, or a liquid such as water may pass through the chamber to also be heated. For instance, solar cells whose efficiency decreases as temperature increases may be cooled with a cool air stream blown into the chamber. Alternatively, natural convection of air may allow heated air to escape and cooler air to enter the chamber where ends are open or where one or more conduits into the chamber admit air.

Cover

A cover 1604, 1704 as depicted in FIGS. 16 and 17 may be formed as discussed above for the solar energy tubular absorber. A movable cover will preferably be transparent where it is positioned in an area receiving light that is to be transmitted to solar energy converters within the housing.

Cover Retracting Mechanism

A cover may be moved from an opening of a transparent housing or replaced to the opening using a cover retractor. A cover retractor may, for instance, rotate or slide the cover away from the opening of the housing. A cover may be attached to the housing by a hinge and may be pivoted away from the opening along the hinge's axis. For a rectangular prism-shaped housing, a downward-facing transparent cover can be pivoted using e.g. a motor and linkage to rotate the cover away from the housing.

A cover may be moved and replaced for a rectangular prismatic-shaped housing, for instance, by providing tracks in which the cover slides. The cover may have a rack and pinion assembly at each end, and the cover may be attached to each rack so that the cover may be slid away from the opening of the transparent housing along the tracks. The cover may be retracted entirely away from the face of the housing in this way so that the housing face as well as the interior of the housing can be washed.

A cover may be moved and replaced for a rectangular prismatic-shaped housing by rotating the cover away from the opening. For instance, linkage attached to the cover at one end and a pivot point past an edge of the housing at the other end of the linkage may be driven by a motor so that the cover follows an arc-shaped path and pivots away from the housing to provide unobstructed access to the opening and the chamber within the housing.

Alternatively, the cover may have a worm drive at each end of the cover and driven by a common motor to rotate the cover away from the opening of the transparent housing. Or, the cover may be hinged on the transparent housing, and the cover may be pivoted away from the opening using a motor and worm drives or linkage.

A cover may be moved and replaced for a rectangular prismatic-shaped housing by extending the cover normal to the surface of the housing suitable linkage and motor and rotating the cover about one or another axis of the cover (e.g. a long axis or a short axis).

A cover may be moved and replaced for a tubular-shaped housing, for instance, by any of the means discussed above for a rectangular prismatic-shaped housing. In addition, the cover may be revolved about the tubular-shaped housing in an arc.

### Mobile Solar Collector

With solar power fields, once the location of the field is determined, analysts typically use information about the area to calculate the amount of PV panels or solar collectors necessary or sufficient to meet the power demands. Characteristics considered may range from, for example, weather information such as solar radiation and average cloud cover, to the surrounding landscape including vegetation that could cast shadows or uneven ground that could pose a challenge during construction. There are a variety of resources available to gather information about the area such as, for example, Solar Radiation Data Manual for Flat-Plate and Concentrating Collectors, which provides monthly averages of solar radiation from 1961-1990, or, for another example, Solar Maps compiled by NREL, which provides monthly average daily total solar resource information on grid cells approximately 40 km by 40 km each. This information is easily accessible to the public and can be used to generate a rough approximation of the amount of power generation possible. These resources, however, often have some uncertainty and may not have the precision specific to a particular acre of land—the size of a potential MicroCSP field. Model estimates derived from information provided from these resources can approximate the power that each collector can generate, but there will be a degree of uncertainty. These approximations may be appropriate for the larger, utility scale CSP fields, but may be too general for MicroCSP technology.

Furthermore, some of these algorithms used to calculate the power generated need direct measurements since the available generic information does not have the required precision. For example, the comparison of Building-Integrated PV model estimates versus actual Building-Integrated PV performance data requires a Mobile Solar Tracking Facility to collect data about the electrical performance of photovoltaic panels. The Mobile Solar Tracking Facility may incorporate meteorological instruments, a solar spectroradiometer, a data acquisition system, and a single-channel photovoltaic curve tracer to collect the input data for a model estimate.

The assessment tools available for photovoltaic panels may not have the capabilities desired for a MicroCSP application. However, there is a demand for direct measurement of MicroCSP in varying locations because the larger size of the fields for MicroCSP may mean that any percentage of error may have a larger impact in comparison to smaller PV fields. Although there are small-scale PV applications that use array sizing worksheets (that calculate the amount of PV panels based on general location and power demands), these applications are generally for small power demands and could lead to inaccurate estimates for larger power demands. Unlike the use of PV as a backup solution, MicroCSP™ preferably can be implemented as a complete energy solution, using conventional technologies as a back-up. This requires more reliable energy production estimates from algorithms that use or can be produced from direct, on-site measurements.

One method of collecting direct measurements on site could utilize a single solar collector (“Mobile Collector”) to produce a miniaturized thermal loop. The Mobile Collector could include some or all of the major components of the thermal loop—such as the solar collector, a pumping system, flow meters, and a heat exchanger. The system could be contained on a single, portable platform, such as a trailer. In addition to a thermal loop, the platform could also include other components, machinery or data collecting devices, such as, for example, a pyrheliometer to measure solar radiation and, as another example, a weather station to measure wind speed, wind direction, temperature, etc. This method of collection would provide direct measurements, which can be used in combination with model estimates calculated from information about the area.

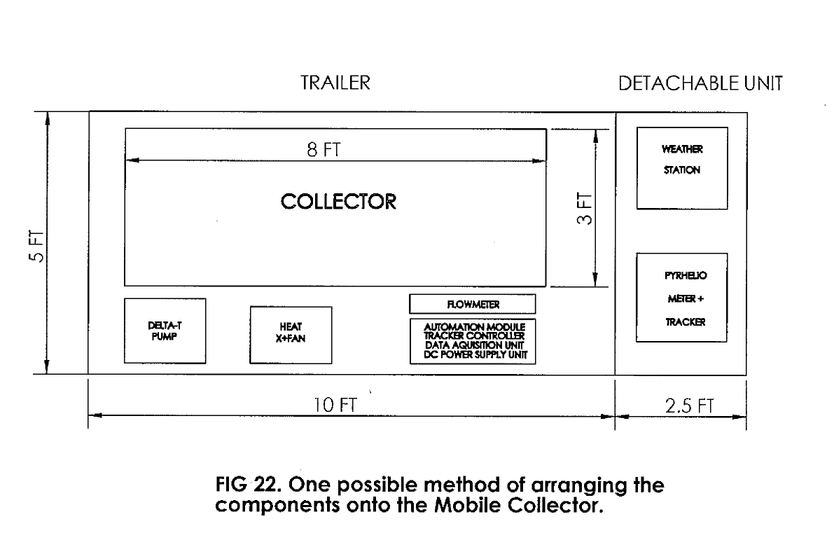

An example setup is shown in FIG. 22, and would create a full thermal loop with a single collector. Over a period of time, which could vary from, for example, a few months to an entire year, or any desired time range or portions or intervals thereof, the unit could collect and record the amount of heat generated by the collector as well as weather information and solar radiation. This type of data collection could utilize a few additional collectors in a single loop and/or place additional Mobile Collectors in strategic places to get a more accurate estimate. When large arrays of collectors are purchased, analysts can compare the data collected by the Mobile Collector to the actual heat generated by an array of collectors. This type of comparison could increase the accuracy of estimates and facilitate assessment of the practicality and efficiency of Micro CSP in varying locations. The benefits of producing more accurate estimates of heat generation of a Micro CSP field include, among others, reducing or eliminating use of excess collectors and optimizing value of investment in the large scale of collectors for a field.

The Mobile Collector provides a method to test a Micro CSP product in a particular location or locations without having to extend the large investment necessary to install an entire field of solar collectors.

There may be certain situations where a single Mobile Collector might not produce enough thermal heat for significant power generation (depending on the amount of power needed for a particular application). In such cases, multiple Mobile Collectors could be linked together to generate heat for small-scale power generation. Single or multiple collectors could be used, for example, for short-term or single-day events such as a gathering in an area that does not have established utilities or sufficient power capabilities. Additional piping could, for example, be used to connect the absorber tubes of these single-collector units. The portability of the trailers allows the collectors to be placed in desired locations with ease, and relocated as needed.

Another potential benefit of the Mobile Collector is that it can be used as an educational or demonstration tool. The portable thermal loop can serve as a model for both potential users and the general public to increase awareness of Concentrated Solar Power as a solution. Unlike large Concentrate Solar Power fields where people must go to the large fields to see the actual technology, the Mobile Collector Micro CSP can go to the viewers.

### Example Advantages of the Mobile Collector

Provides data for collector fields location, size and position selection
Improves techniques used to analyze the technology as well as the locations for Micro CSP solutions
Allows technology to be tested before substantial investment
Increases technology exposure

### Using the Mobile Collector for Data Collection

One of many possible implementations of the Mobile Collector would mount the thermal loop to the trailer and include a detachable unit that contains a weather station and pyrheliometer.

The Thermal Loop could be substantially identical to those used in Micro CSP such that the collector could have an absorber tube running across the collector at the focal point of the parabola. A pumping unit could run/pump the fluid through the thermocouple at the beginning of the loop to measure the Tin (Temperature in) before it passes through the collector. As the fluid flows through the collector, it can be heated before it passes through a second thermocouple that measures the Tout (Temperature out). Then the fluid can be cooled by a Heat Exchanger and Fan. The fluid could pass through the flowmeter before returning to the pumping unit to repeat the loop. The components in this loop—thermocouple for Tin, collector, thermocouple for Tout, Heat Exchanger and Fan, and flowmeter—could, for example, be connected with 1″ copper piping that could be brazed together.

The pumping unit can be used to ensure that the fluid is moving through the loop at the correct rate. The thermocouples that measure the Tin and the Tout are necessary to determine the temperature difference generated by the heat collection. The Heat Exchanger and Fan may be used in this implementation of the Mobile Collector to cool the fluid before it reenters the loop. In larger fields of collectors the process in which the heat is used—power generation, process heat, air conditioning, etc.—could cool the fluid. Since these processes are not used in data collection, a heat exchanger and fan is preferred. However, in a different implementation of the Mobile Collector (for example, multiple Mobile Collectors and connected together for short-term power generation), a heat exchanger and fan might not be necessary and instead may have a low-temperature turbine, for example, in its place. The flowmeter in the loop can be used to measure the flow of the fluid, which can also be used for data analysis.

The detachable unit in a preferred implementation could include a weather station and a pyrheliometer. The weather station could be used, for example, to gather information about wind velocity (speed and direction) and ambient temperature. The pyrheliometer, which typically requires a separate tracking system, could measure solar radiation at normal incidence. (Normal incidence is when the raypath is perpendicular to the interface. In this case, the raypath is the path of the solar radiation and the interface is the pyrheliomether, which is why the pyrheliometer preferably should continually track the sun.) In other implementations, other data may be collected and integrated in the analysis of the location. Since this unit is detachable, it may not be used if the data collection is not the primary function (for example, short-term power generation).

A data logging unit could record the information from the thermal loop (Tin, Tout, flow), radiation at normal incidence from the pyrheliometer, and wind velocity, ambient temperature, etc. from the weather station. If connected to the interne, this unit could stream information about the location to the client or the company for faster analysis. Otherwise, the data could be collected and retrieved on-site.

While various designs are possible, the collector installed in a preferred implementation of the Mobile Collector is a parabolic trough design—the same technology utilized in Micro CSP. This collector preferably utilizes a time-based tracking system since the collector is the most efficient when it faces the sun directly. By utilizing the time-based tracking system, the collector would be fully functioning and would replicate the current technology being used in Micro CSP, providing the most realistic data possible. See attached Appendix A for an example of a tracking system.

In other implementations, however, different types of collectors and tracking systems could be used in a comparison test. This could lead to customized solutions. Also, other types of solar power technology could be used to obtain the same, or comparable, portability benefits.

### Other Possible Implementations of the Mobile Collector

Different implementations of the Mobile Collector could involve different setups and considerations. A few variations are described here, by way of example.

In the use of multiple Mobile Collector units for short-term power generation more fluid likely would need to be heated and/or a greater raise in temperature likely would be necessary. As mentioned earlier, conventional fields achieve this by using long rows of collectors. A miniature field could be created with the Mobile Collector units. Either the absorber tubes could be connected to allow for more fluid to be heated to greater temperatures or each Mobile Collector could have a turbine to generate electricity that could later be pooled together.

To assess options, there may be different variations on the Mobile Collector unit to test different types of collectors and tracking systems. Using different size and models of solar collectors can provide accurate data as to how each type responds to the environment proposed for the Micro CSP field. Different tracking systems may also have an effect on the amount of thermal heat collected. The Mobile Collector could be useful in this setting because using a field of collectors for this type of testing could be wasteful. It could also be helpful to do specific on-site testing (as opposed to general testing of the collectors and tracking systems) because of the unique characteristics of each site. For example, if the location is not perfectly in line with the Earth's North-South line (which is relevant to the time-based tracking system), a different photovoltaic-based tracking system may be beneficial.

The Mobile Collector also could be fitted with large displays that show the data being collected. For example, the data logging unit, connected to the interne, could stream to a computer that could display the information, preferably in a user-friendly interface. Another more hands-on approach, could have LED displays, for example, near each device to show exactly where each piece of information is collected. In addition, a laser can be used to show the paths of various rays. The Mobile Collector could also have a mirror or camera to show whether a laser is being reflected onto the tube, depending on whether the incoming laser beam is parallel to the axis of symmetry.

The embodiments described herein are provided by way of example only and the invention is not limited to the specific examples provided.

What is claimed is:

1. A solar energy absorber comprising
(a) a solar energy converter;
(b) a transparent housing having an opening and containing at least a portion of the solar energy converter within a chamber of the housing; and
(c) a cover for covering the opening, wherein at least one of the transparent housing and cover is movable.

2. An absorber according to claim 1 wherein the solar energy converter comprises at least one solar-to-thermal energy collection pipe.

3. An absorber according to claim 1 wherein the transparent housing has a tubular shape.

4. An absorber according to claim 3 wherein the opening extends parallel to a longitudinal axis of the housing.

5. An absorber according to claim 1 wherein the cover is reflective.

6. An absorber according to claim 1 wherein the cover is transparent.

7. An absorber according to claim 1 wherein the cover is movable.

8. An absorber according to claim 1 wherein the transparent housing is movable.

9. An absorber according to claim 1 wherein the transparent housing is tubular and the housing is rotatable about a longitudinal axis of the housing.

10. An absorber according to claim 9 wherein the cover encounters a stop as the cover and the tubular housing are rotated, said stop configured to stop the cover but not the tubular housing.

11. A solar energy absorber according to claim 1 wherein
(a) the solar energy converter comprises a solar-to-thermal energy collection pipe positioned to receive solar energy from a mirror, and
(b) wherein said opening of the transparent housing extends along at least a portion of a length of the transparent housing.

12. A solar energy absorber according to claim 11 wherein
(a) the transparent housing comprises a transparent tube about the solar-to-thermal energy collection pipe, and wherein
(b) said opening of the transparent housing comprises an opening extending along at least a portion of a length of the transparent tube.

13. A solar energy absorber according to claim 11 wherein
(a) said cover is movable, and
(b) said solar-to-thermal energy collection pipe has a solar energy-absorbing coating layer.

14. A method of operating a solar energy collector comprising illuminating with sunlight a solar energy converter positioned within a transparent housing having an opening and a cover covering the opening, wherein at least one of the cover and the transparent housing through which the sunlight is transmitted is movable.

15. A method according to claim 14 wherein the solar energy collector comprises a trough solar energy collector, wherein the solar energy converter comprises a solar-to-thermal energy collection pipe, wherein the transparent housing comprises a transparent tube positioned about the solar-to-thermal energy collection pipe, wherein the opening of the transparent tube is covered by a movable cover; and wherein the act of illuminating the solar-to-thermal energy collection pipe comprises concentrating the sunlight upon the solar-to-thermal energy collection pipe.

16. A method according to claim 15 and further comprising, prior to illuminating the tube,
(a) inverting the trough solar energy collector to expose the opening in the transparent tube positioned about the solar-to-thermal energy collection pipe, and
(b) washing the collection pipe and an interior surface of the transparent tube.

17. A method of making a solar energy collector comprising
(a) placing a transparent housing about a solar energy converter, the transparent housing having an opening on a side through which sunlight is to be transmitted, and
(b) placing a cover on said opening.

18. A method according to claim 17 wherein the transparent housing comprises a transparent tube, the solar energy converter comprises a solar-to-thermal energy collection pipe, the transparent tube has an interior diameter greater than an external diameter of the solar-to-thermal energy collection pipe, and the opening of the transparent tube extends along a longitude of the transparent tube.

19. A method according to claim 17, wherein the method further comprises providing one or more coverings for said one or more openings of the transparent tube.

20. A method according to claim 17, wherein the one or more openings are formed in the transparent tube by cutting a portion of the transparent tube to remove a section.

21. A method according to claim 20, wherein the section is a longitudinal arcuate section of the transparent tube.

22. A method according to claim 21 wherein the opening of the transparent tube extends from a first end of the transparent tube to a second end of the transparent tube.
